(19) United States
(12) Patent Application Publication
(10) Pub. No.: US 2002/0014359 A1
(43) Pub. Date: Feb. 7, 2002

(54) Autocycle

(76) Inventor: Stuart D. Schooler, Bethesda, MD (US)

Correspondence Address: Christopher J. McDonald, Esq., HOFFMAN, WASSON & GITLER, PC, Suite 522, 2361 Jefferson Davis Highway, Arlington, VA, 22202, US

(21) Appl. No.: 09/908,709

(22) Filed: Jul. 20, 2001

Related U.S. Application Data
(60) Provisional application No. 60/219,643, filed on Jul. 21, 2000.

(51) Int. Cl. B60K 6/00

(52) U.S. Cl. 180/65.2

(57) ABSTRACT

The invention uses electrical power generated by the occupants of the vehicle to supplement that power supplied by a battery in a vehicle utilizing an electric motor. The power is generated by an occupant of the vehicle operating pedals. This vehicle may be either an electric vehicle or a hybrid vehicle. By adding electrical power generated by the occupants, the amount of power drawn from the batteries is reduced, extending the range attainable by an electric vehicle. Also, in a hybrid vehicle, the operation time of non-battery energy generation source, such as the conventional internal combustion engine, is reduced.

This application claims the benefit of provisional patent application Serial No. 60/219,643, filed Jul. 21, 2000.

### FIELD OF THE INVENTION

The invention relates to vehicles using alternative energy sources.

### BACKGROUND OF THE INVENTION

The use of alternative fuel vehicles is gaining in popularity and importance as the advantages of these vehicles over conventional vehicles are realized. The most popular type of alternative fuel vehicles is the electric vehicle. The electric vehicle uses a large number of batteries to power the vehicle with an electric motor. The disadvantages of an electrical vehicle are their limited range and the inconvenience and lack of facilities for recharging the vehicle. A solution to the problems found with electrical vehicles can be found in hybrid vehicles. Hybrid vehicles use both a conventional internal combustion engine along with an electric motor as the power source. The car can operate under power from either or both the conventional motor and electric motor. These vehicles eliminate the problems associated with the limited range and recharging problems inherent with electrical vehicles. Hybrid vehicles, however, do have the pollution and other problems associated with conventional vehicles which are sought to overcome with alternative fuel vehicles.

It is an object of the invention to add energy to existing storage medium vehicles having an electric motor.

It is another object of the invention to reduce the operation time of the non-electric energy source of a hybrid vehicle.

It is another object of the invention to extend the range of a vehicle having an electric source powered by a battery.

It is still another object of the invention to modify existing electric or hybrid vehicles to add another source of energy input.

These and other objects will become apparent to one of ordinary skill in the art after reading the disclosure of the invention.

### SUMMARY OF THE INVENTION

The invention uses electrical power generated by the occupants of the vehicle to supplement that power supplied by a battery in a vehicle utilizing an electric motor. The power is generated by a vehicle occupant when they operate the pedals. This vehicle may be either an electric vehicle or a hybrid vehicle. By adding electrical power generated by the occupants to the batteries, the amount of power drawn from the batteries is reduced, extending the range attainable by an electric vehicle. Also, in a hybrid vehicle, the operation time of non-battery energy generation source, such as the conventional internal combustion engine, is reduced.

A vehicle having the additional energy input supplied by the occupants increases the flexibility afforded by the vehicle. The vehicle does not rely upon the energy source supplied by the occupant but allows such additional energy input to increase the range of the vehicle and reduce its engine emissions. The invention has the added benefit of giving the occupant an aerobic workout while traveling or commuting. The addition of the occupant supplied power source increases the fleet fuel economy requirements in CAFE calculations. This also allows for larger, higher powered ultra low emission vehicles.

### BRIEF DESCRIPTION OF THE DRAWINGS

FIG. 1 is a schematic diagram of the invention;

FIG. 2 is a block diagram of the invention;

FIG. 3 is a schematic of the invention added to an existing hybrid vehicle; and

FIG. 4 is a block diagram of the invention applied to an existing hybrid vehicle.

### DETAILED DESCRIPTION OF THE INVENTION

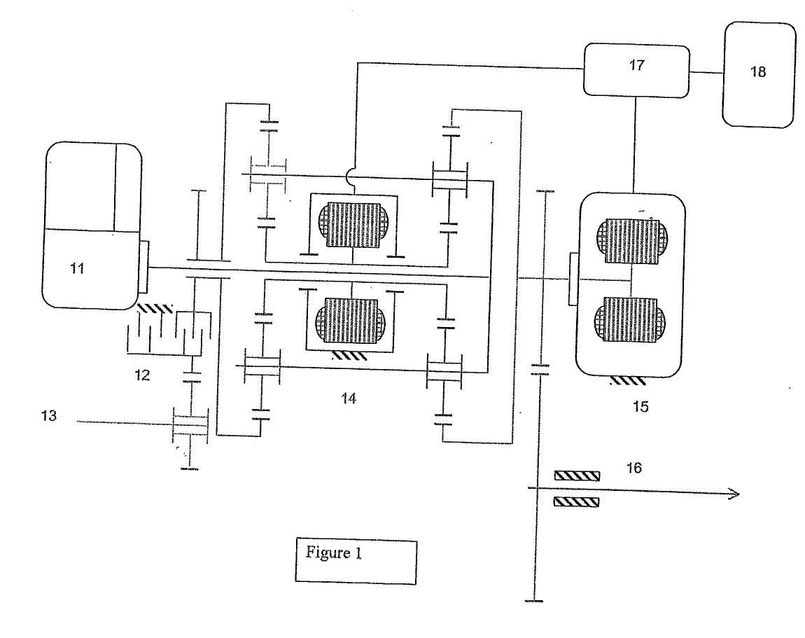

The invention is depicted in FIG. 1 which shows a schematic of the elements comprising the invention and how they are connected to one another. The vehicle has a conventional internal combustion engine 11 and an AC electric motor 15 supplying power to the drive train 16. The engine supplies power directly to the drive train or is connected to a generator 14. The generator 14 converts the power supplied by the engine 11 into electrical power to be supplied to the electric motor. The generator outputs direct current (DC) converted by an inverter 17 to be used by the electric motor.

The electric motor also receives power from the battery 18. The battery supplies DC current which needs to be converted to AC current. For that reason, the battery is connected to inverter 17. The power output from the inverter 17 is supplied directly to the electric motor. This arrangement of the electric motor and conventional motor used to power the drive train of the vehicle is the usual arrangement for a hybrid vehicle.

The occupant of the vehicle has the option of operating pedals. The pedals are accessible to the occupant and can be stored in a well below the floor boards. The occupant would remove a panel covering the well. The pedals have a latch or spring-loaded button to release the pedals. The transfer mechanism between the pedals and generator is either a gear, belt, shaft, chain or other conventional mechanism.

The operation of the pedals generates mechanical energy supplied to the generator 14. The generator converts the mechanical energy input by the pedals into electrical energy.

The generator output is passed through the inverter 17 to convert the DC current into AC current. The power converted by the inverter is supplied to the electric motor 15. It is to be noted that the same inverter 17 is able to convert energy from the generator and the battery from DC to AC. Of course, separate inverters can be used.

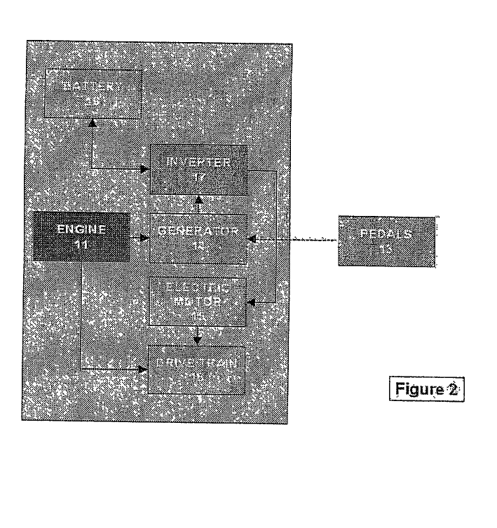

Turning to FIG. 2, the block diagram shows the various elements of the invention. The arrows indicate the flow of power between the related elements. As is seen, the engine 11 has outputs to either or both of the drive train 18 or generator 14. The generator also receives energy input by the pedals 13 when operated by a passenger of the vehicle. The mechanical energy supplied by the engine 11 and the pedals 13 is converted by the generator 14 into electrical energy. The electrical energy output by the generator is passed through an inverter 17. The inverter receives energy from either or both the generator and the electrical battery. The electrical energy supplied by these two sources is converted from DC into AC and supplied to the electric motor 15 or stored in the rechargeable batter 18. The electric motor is operable to drive it to operate the drive train 16.

As can be seen by this arrangement, an electric motor and a conventional gas engine are coupled with an energy source supplied by the pedals as operated by the vehicle's occupant(s). Mechanical energy generated by the pedals is converted into electrical energy. The electrical energy derived from the operation of the pedals reduces the energy output, increases energy input by/to the battery and therefore extends the range of a battery-operated vehicle. This is particularly important if the vehicle is an electrical vehicle and does not have the conventional engine to operate the drive train. In a hybrid vehicle with a conventional engine, it is sought to have more energy supplied by electrical sources thereby reducing the amount of pollution generated by the conventional engine since the gas engine will now be a lesser used source of energy.

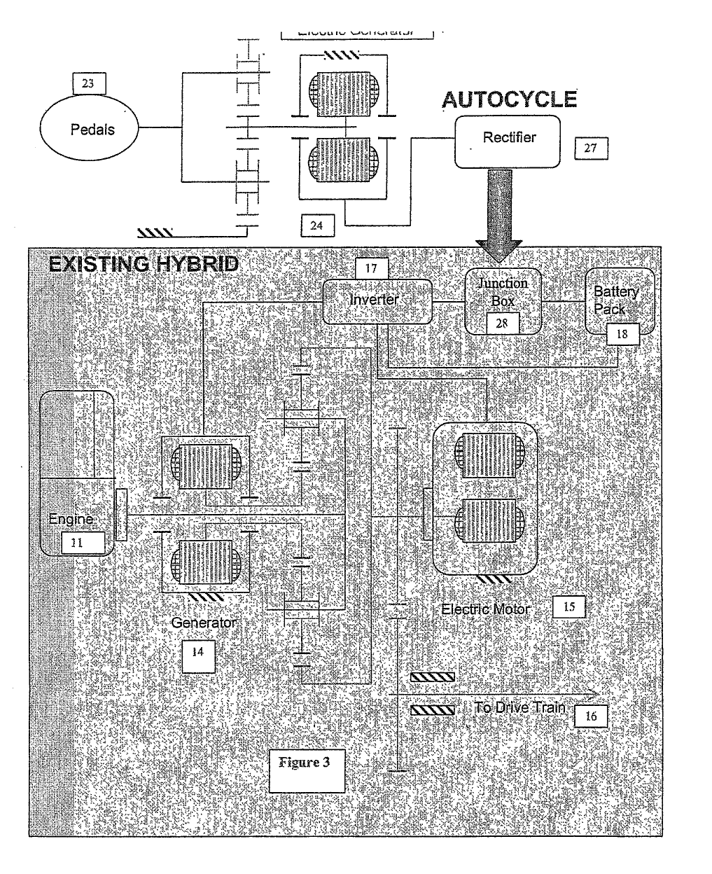

FIG. 3 shows the schematic of the invention being applied in an aftermarket manner to an existing hybrid vehicle. Similar elements retain the same reference numerals. The existing hybrid vehicle has a conventional engine 11 providing power directly to the drive train 16 or to a generator 14. The generator converts the mechanical energy provided by the engine into electrical power. This electrical power is supplied to an electric motor 15. The DC electrical output from the generator is passed through an inverter 17 to convert the power supplied by the generator 14 into AC usable by the electric motor 15. The electric motor also receives power from the battery pack 18. The battery pack supplies DC power converted into AC power through the inverter 17.

In order to realize benefits of the invention, pedals 23 are added to the vehicle. The mechanical energy supplied by the operation of the pedals 23 by the vehicle occupant are converted into electrical energy by an AC electrical generator 24. The AC current supplied by the electric motor is converted by a rectifier 27 to produce DC current. This DC current is supplied to a junction box 28. The junction box is connected between the battery pack and the inverter. The junction box prevents any battery failure by outputting a desirable current. Current is supplied to the junction box by the hybrid's generator and the pedals' generator. The junction box insures that the inputs into the battery pack 18 by the generator 14 in the existing hybrid vehicle and the rectifier 27 of the aftermarket addition of the pedals does not damage the battery.

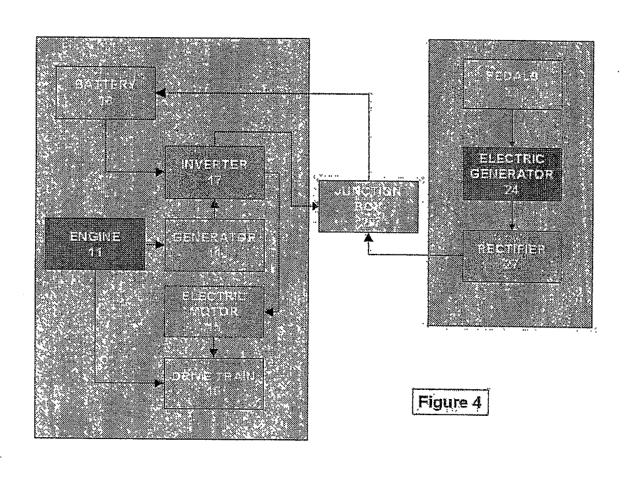

The arrangement of elements and flow of electrical power can be seen most clearly in the block diagram of FIG. 4.

The flow of power between the elements is depicted by the direction of the arrows. As can be seen, the conventional engine supplies power either directly to the drive train 16 or to the generator 14. If supplied to the generator, the mechanical power is converted into electrical power. The electrical energy output by the generator is passed through a converter to result in AC power usable by the electric motor 15. The electric motor also receives electrical energy from the battery 18 via the inverter. The DC current, supplied by the battery, is converted by the inverter 17 used by the generator 14 into AC current and is sent to operate the electric motor. The electric motor, powered by either the battery, pedals' generator, the hybrid's generator, or a combination thereof, is used to operate the drive train.

The existing hybrid vehicle is adapted to receive electrical energy generated by operation of the pedals. The pedals are connected to an electrical generator to generate electric current. The rectifier converts the AC output to a DC current. This DC power is passed into a junction box. The junction box receives the electrical power generated by the pedals and by the generator of the existing hybrid vehicle. The junction box receives the two power sources and outputs this energy to the rechargeable battery. The junction box outputs electrical power that is compatible with the battery and will not cause failure of the battery. As can be seen, power input into the battery through the junction box by the generator or the pedals is stored in the battery to be used by the electric motor.

The DC current output by the battery is passed through an inverter before being used by the AC electric motor.

If the pedals are attached to a DC electrical generator, the inverter is no longer needed and a transformer is used in its place. The transforming function can either be performed in the junction box or it can be accomplished in a transformer (whose signal is then sent to the junction box).

While the invention has been described with reference to preferred embodiments, the description is not intended to be limited. Various modifications and variations would be obvious to one of ordinary skill in the art without departing from the scope of the invention. For instance, the generator and electric motor shown in the configurations of FIGS. 1 and 2 can be either both AC or DC. In this instance, power output from the generator can be used directly with the electric motor without need for an inverter or rectifier. In the instance where the electric motor is AC, the DC power output by the battery would still need to be converted by the inverter. Also, separate generators can be used to convert the mechanical energy of the pedals and conventional engine in the embodiment shown in FIG. 1.

I claim:

1. An alternative fuel vehicle, comprising:
a battery supplying electrical power;
an electric motor receiving said electrical power from said battery and converting said electrical power into mechanical power;
a drive train receiving said mechanical energy for moving said vehicle;
pedals operable by an occupant of said vehicle to create mechanical power; and
a first generator converting said mechanical energy for said pedals to first electrical power, said first electrical energy from said generator supplied to said electric motor.

2. The alternative fuel vehicle of claim 1, further comprising an internal combustion engine supplying power to said drive train.

3. The alternative fuel vehicle of claim 2, wherein said internal combustion engine supplies mechanical power to a second generator, said second generator converting said mechanical power from said internal combustion energy into second electrical power, said electric motor receiving said second electrical energy.

4. The alternative fuel vehicle of claim 3, wherein said first generator and said second generator are the same generator.

5. The alternative fuel vehicle of claim 3, further comprising a junction box, said junction box receiving said first electrical power from said first generator, said junction box sending said first electrical power to said battery, said junction box regulating said first electrical energy to protect said battery.

6. The alternative fuel vehicle of claim 1, wherein said electric motor is an AC motor and further comprising an inverter for converting DC power from said battery to AC power.

7. The alternative fuel vehicle of claim 1, wherein said first generator is a AC generator and further comprising a rectifier for converting AC power produced by said first generator to DC power.

8. The alternative fuel vehicle of claim 3, wherein said electric motor is an AC motor and further comprising an inverter for converting DC power from said battery to AC power.

9. The alternative fuel vehicle of claim 8, wherein said second generator is a DC generator producing DC power, said inverter converting said DC power to AC power.
